(19) United States
(12) Patent Application Publication
(10) Pub. No.: US 2004/0152476 A1
(43) Pub. Date: Aug. 5, 2004

(54) Mobile communication system, radio terminal used therefor, radio network controller and operation control method therefor

(75) Inventors: Hiroaki Kuwano, Tokyo (JP); Masahiko Kojima, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/747,962

(22) Filed: Dec. 31, 2003

(30) Foreign Application Priority Data
Jan. 10, 2003 (JP) 2003-004713

(51) Int. Cl. H04Q 7/20

(52) U.S. Cl. 455/459

(57) ABSTRACT

It is an object of the present invention to eliminate congestion of radio channels due to paging in paging processing in a service of an MBMS to prevent UEs using other services from being affected by the congestion. The present invention uses a TMGI (Temporary Mobile Group Identify), which is an identifier peculiar to an MBMS service, instead of an IMSI, which is an identifier peculiar to a UE, to prepare a paging message on the basis of this TMGI and determine a Paging Occasion (transmission frame timing of a PICH) and a PI bitmap. Consequently, since it becomes possible to send the paging message with a group of UEs subscribing to an identical MBMS service as a unit, congestion of radio channels due to the transmission of the paging message is eliminated.

### BACKGROUND OF THE INVENTION

1. Field of the Invention

The present invention relates to a mobile communication system, a radio terminal used therefor, a radio network controller and an operation control method therefor. In particular, the present invention relates to a mobile communication system, which has a function of delivering identical service data including large volume contents such as voices and images to a plurality of radio terminals (users), and a radio terminal used therefor, as well as a radio network controller and an operation control method therefor.

2. Description of the Related Art

In a WCDMA mobile communication system, processing of a paging signal is started with a notification from a CN (core network) to an RNC (radio network controller), which notifies that user data for a specific UE (radio terminal) has been delivered (or received), as a trigger. The paging signal includes a paging message. The paging signal has a signal accompanying it, and the UE receives the accompanying signal to judge whether or not the paging signal should be received. The accompanying signal bears a paging identifier PI (Paging Indication). This paging identifier PI corresponds to identifiers (IMSIs: International Mobile Subscriber identify) of a plurality of UEs.

More specifically, in a radio channel between a NodeB and a UE, a paging signal is mapped to an S-CCPCH (Secondary-Common Control Channel) which is a common channel in the downlink direction. A signal accompanying this signal is a PICH (Paging Indicator Channel) and is a signal for notifying presence or absence of incoming call information for each paging group (incoming call group). For example, a UE belonging to a certain paging group #n receives, in the case in which the UE is notified by the PICH that there is an incoming call for the paging group #n, a PCH (Paging Channel) in a corresponding radio frame mapped to the S-CCPCH.

The UE having received the paging signal of the PCH confirms whether an identifier, which is a terminal number of its own, is included in a paging message. If the identifier of its own is included in the paging message, the UE recognizes that user data has been delivered to the UE (or the incoming call has been received). Identifiers (IMSIs) of a plurality of UEs can be included in the paging message. Consequently, even if a plurality of notifications on incoming calls are simultaneously sent from a plurality of CNs, the notifications can be multiplexed in one paging message. By the multiplexing, a total amount of signals of the paging message can be reduced.

The RNC needs to prepare a paging message including an appropriate terminal number. The paging signal is set at specific timing. Since the UE does not need to always wait a paging signal if it knows this specific timing, electric power is saved. A state in which the UE is waiting for the paging signal in this way is called a standby (waiting) state. The UE periodically receives the paging signal while it is in this standby state. If the number of times of repeated transmission of the paging signal is increased, a probability of paging signal reception in the UE increases. On the other hand, radio resources in the downlink are wasted.

The RNC calculates transmission timing of the paging signal to a certain UE and instructs a NodeB (radio base station) of a result of the calculation. Contents of the instructions to the NodeB are information necessary for generating a signal (PICH) accompanying the paging signal and transmission timing of the paging signal. The RNC needs to instruct timing (Paging Occasion) for the NodeB to send the paging signal (the signal accompanying the paging signal). In addition, the RNC also needs to send a necessary signal to the NodeB. Further, the RNC needs to determine a paging identifier PI as information necessary for generating the signal accompanying the paging signal.

The above-described paging processing is disclosed in detail in “W-CDMA Mobile Communication System”, supervised by Keiji Tachikawa, Maruzen Co., Ltd., 2001, pages 114 to 115 and 222 to 223, and 3GPP TS25.304, Chapter 8. The paging processing will be hereinafter described further with reference to the drawings. Concerning the above-described S-CCPCH, a plurality of S-CCPCHs are used in order to prevent UEs from concentrating in one S-CCPCH, and a pertinent S-CCPCH is selected out of the S-CCPCHs by using an IMSI serving as an identifier. For example; as shown in FIG. 7, if there are two S-CCPCHs, in a network in which a plurality of UEs 20 exist, an expression (IMSI)mod(2) is calculated to determine an S-CCPCH to be selected.

Next, as shown in an example of frame numbers of a PICH in FIG. 8, one paging occasion is allocated to the UEs for each cycle length of DRX (Discontinuous Reception) at the standby state of the UEs. Thus, a period of an SFN (Serial Frame Number) of the PICH for carrying out paging can be recognized according to this paging occasion. By this, the UEs are divided into a plurality of groups, each of which performs paging processing, on the basis of the same SFN. In other words, this paging occasion is equivalent to determining an SFN of the PICH. The SFN is determined according to an IMSI and a DRX cycle length.

Thus, the UEs using the same S-CCPCH can be divided into, for example, a plurality of groups A to C as shown in FIG. 9 according to the IMSI. Here, in the case in which the DRX cycle length is “128” as shown in FIG. 8, as shown in FIG. 10, the UEs belonging the group A execute paging processing (check if there is an incoming call for each of the UEs) at timing of SFN=0, 128, 256, . . . ; the UEs belonging to the group B execute paging processing (check if there is an incoming call for each of the UEs) at timing of SFN=1, 129, 257, . . . ; and the UEs belonging to the group C execute paging processing (check if there is an incoming call for each of the UEs) at timing of SFN=2, 130, 258, . . . .

When the SFN (Paging Occasion), at which the paging processing is started, is determined in this way, then, bitmap positions of paging identifiers (PIs) in a PICH are required to be determined in order to find whether there is a paging request or not. The number Np of PIs, which can be set in one frame of this PICH, is defined in advance (Np=18, 36, 72, 144), and bit positions of a pertinent PI are determined using the IMSI.

For example, the UEs belonging to the group A can be divided into smaller groups (PI0, PI1, PI2) according to the PIs as shown in FIG. 11. A frame structure of the PICH is as shown in FIG. 12, in which PIs of total 288 bits from 0 to 287 bits exist, and numbers of continuous bits of the PIs are different depending upon a value of Np (see FIG. 13). Note that total twelve bits from 288 to 299 bits are unused. The UEs check pertinent bits and judge whether or not a paging signal has been sent. In the end, the UEs standing by for a paging signal check whether or not the paging signal is one for the UEs on the basis of the IMSI, whereby a pertinent UE is finally determined.

Note that a method of determining paging occasion (PO) and a method of determining a PI bit map are defined in 3GPP TS25.304, Chapter 8. Expressions (1) and (2) for the determination are cited in FIGS. 14 and 15, respectively. In these expressions, “div” indicates a division and “mod” indicates a residue of the division.

In such a mobile communication system, there is a service for delivering (broadcasting/multicasting) large volume data of identical contents including voices and images to a plurality of radio terminals. Such a service is called an MBMS (Multimedia Broadcast Multicast. Service). Referring to FIG. 16, a BMSC (Broadcast Multicast Service Center) 1 is connected to an RNC (Radio Network Controller) 4 via a GGSN (Gateway GPRS (General Packet Service) Support Node) 2 and an SGSN (Serving GPRS Support Node) 3.

The RNC 4 has a NodeB (radio base station) 6 under its control, and the NodeB 6 covers one or more cells which are service areas. In the figure, for simplification of explanation, the NodeB is shown to cover one cell 9. Reference numeral 20 denotes a UE (user equipment) which indicates a radio terminal.

In such a constitution, it is assumed that a plurality of UEs 20 in the cell 9 receive an identical MBMS service. When an “MBMS NOTIFICATION” message for notifying that MBMS service data is to be delivered from the BMSC 1 is sent to the RNC 4 via the GGSN2 and SGSN 3, the RNC 4 determines the PO (Paging Occasion) and the PI (Paging Indicator) on the basis of an IMSI of a radio terminal of a user who receives the MBMS service, prepares a paging message, and sends the paging message to a pertinent UE.

In this case, the paging message is prepared using an IMSI peculiar to individual UEs. Thus, paging messages equivalent to the number of UEs subscribing to the MBMS service are sent, and congestion of radio channels due to the paging occurs, which adversely affects UEs using other services.

### SUMMARY OF THE INVENTION

It is an object of the present invention to provide a mobile communication system, which is capable of eliminating congestion of radio channels due to paging in paging processing in a service of an MBMS to prevent UEs using other services from being affected by the congestion, and a radio terminal used therefor, as well as a radio network controller and an operation control method therefor.

A mobile communication system according to the present invention is a mobile communication system having a function of delivering data of an identical service to a plurality of radio terminals, which is characterized in that information for paging with respect to a radio terminal, which receives delivery of the service, is generated using identification information peculiar to the service.

A radio network controller according to the present invention is a radio network controller in a mobile communication system having a function of delivering data of an identical service to a plurality of radio terminals, which is characterized by including means which generates information for paging with respect to a radio terminal, which receives delivery of the service, using identification information peculiar to the service.

A operation control method for a radio network controller according to the present invention is an operation control method for a radio network controller in a mobile communication system having a function of delivering data of an identical service to a plurality of radio terminals, which is characterized by including a step of generating information for paging with respect to a radio terminal, which receives delivery of the service, using identification information peculiar to the service.

A radio terminal according to the present invention is a radio terminal in a mobile communication system having a function of delivering data of an identical service to a plurality of users, which is characterized in that identification information peculiar to the service is received from a network side at the time when the radio terminal joints the service, and information for paging is received on the basis of this identification information.

A program according to the present invention is a program for causing a computer to execute an operation control method for a radio network controller in a mobile communication system having a function of delivering data of an identical service to a plurality of radio terminals, which is characterized by including a step of generating information for paging with respect to a radio terminal, which receives delivery of the service, using identification information peculiar to the service.

Operations of the present invention will be described. The present invention uses a TMGI (Temporary Mobile Group Identify), which is an identifier peculiar to an MBMS service, instead of an IMSI, which is an identifier peculiar to a UE, to prepare a paging message on the basis of this TMGI and determine a PO and a PI. Consequently, since it becomes possible to perform paging processing with a group of UEs subscribing to an identical MBMS service as a unit, congestion of radio channels due to the paging processing is eliminated.

### BRIEF DESCRIPTION OF THE DRAWINGS

FIG. 1 is a schematic block diagram to which an embodiment of the present invention is applied;

FIG. 2 is a functional block diagram showing an embodiment of an RNC in the present invention;

FIG. 3 is a sequence diagram showing an operation of the embodiment of the present invention;

FIG. 4 is a diagram showing an expression for determining a paging occasion (PO) in the embodiment of the present invention;

FIG. 5 is a diagram showing an expression for determining a paging indicator (PI) in the embodiment of the present invention;

FIG. 6 is a block diagram illustrating an effect of the present invention;

FIG. 7 is a diagram for explaining paging processing;

FIG. 8 is a diagram showing a frame structure of a PICH accompanying an S-CCPCH serving as a paging signal;

FIG. 9 is a diagram showing division of UEs into groups according to one S-CCPCH;

FIG. 10 is a diagram showing an example of a paging occasion for each group divided as shown in FIG. 9;

FIG. 11 is a diagram in the case in which a group A shown in FIG. 9 is further divided into groups according to a paging indicator (PI);

FIG. 12 is a diagram showing an example of a PI bit string of a PICH;

FIG. 13 is a diagram showing the number of continuous bits of a PI for each Np;

FIG. 14 is a diagram showing an expression for determining a paging occasion (PO) in the prior art;

FIG. 15 is a diagram showing an expression for determining a PI in the prior art; and

FIG. 16 is a diagram for explaining a conventional paging message.

### DETAILED DESCRIPTION OF THE PREFERRED EMBODIMENTS

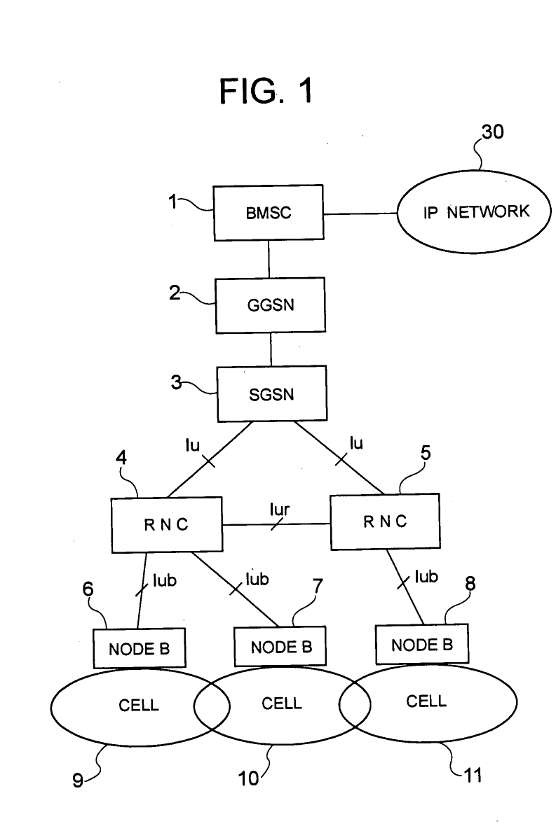

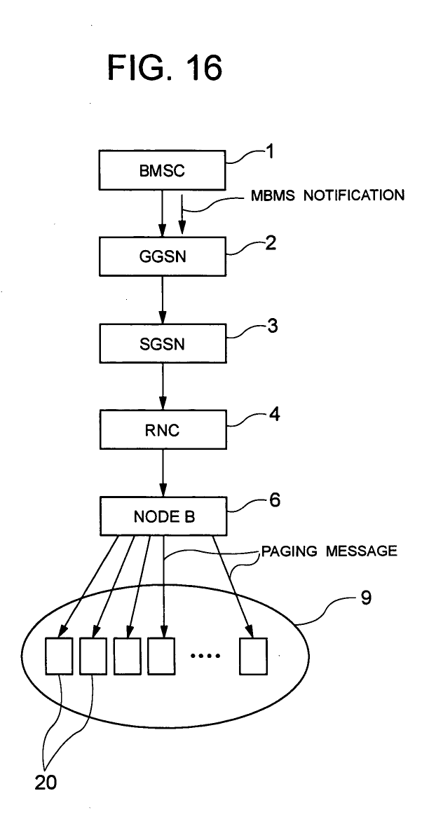

An embodiment of the present invention will be hereinafter described with reference to the accompanying drawings. FIG. 1 is a schematic block diagram of a mobile communication system to which the embodiment of the present invention is applied. Portions equivalent to those in FIG. 16 are denoted by the identical reference numerals and symbols. Referring to FIG. 1, a BMSC 1 is connected to an IP (Internet Protocol) network 30 and is also connected to a plurality of RNCs (radio network controllers) 4 and 5 via a GGSN 2 and an SGSN 3.

The RNC 4 has NodeBs (radio base stations) 6 and 7 under its control, and the RNC 5 has a NodeB 8 under its control. The respective NodeBs 6 to 8 are adapted to cover one or more cells 9 to 11 which are services areas. However, for simplification, each NodeB is shown to cover one cell. Note that, although not specifically illustrated, a radio terminal serving as a UE (user equipment) is in a zone of each cell.

Note that an interface between the SGSN 3 and the RNCs 4 and 5 is referred to as Iu, and an interface between the RNCs 4 and 5 and the NodeBs 6 to 8 are referred to as Iub. Moreover, Iur also exists as an interface between the RNCs 4 and 5.

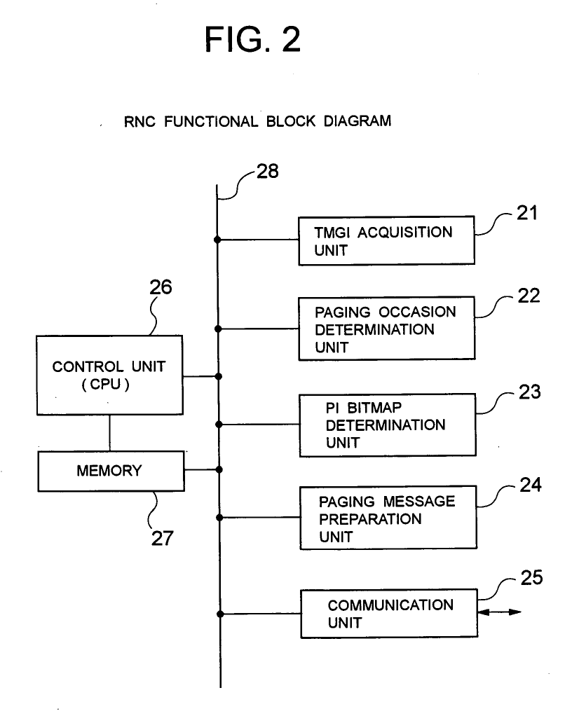

FIG. 2 is a schematic functional block diagram showing an embodiment of an RNC of the present invention. In the figure, a TMGI acquisition unit 21 is a unit which, when an “MBMS NOTIFICATION” message for notifying that MBMS service data is to be delivered is received from the BMSC 1 via a communication unit 25, acquires a TMGI included in this message. This TMGI is a group identifier peculiar to an MBMS which is temporarily given in the system in order to identify an MBMS service.

A PAGING OCCASION determination unit 22 is a unit for determining frame timing (PO) of the above-described PICH, and determines the PO on the basis of the TMGI acquired by the TMGI acquisition unit 21. A PI bitmap determination unit 23 is a unit for determining a PI bitmap of the PICH and determines the PI bitmap on the basis of the TMGI acquired by the TMGI acquisition unit 21.

A paging message preparation unit 24 is a unit for preparing a paging message according to the PO and the PI bitmap, which are determined by the PAGING OCCASION determination unit 22 and the PI bitmap determination unit 23, respectively, and the TMGI. A communication unit 25 is a unit for performing communication with the NodeB and also performing communication with the SGSN 3 which is an upper device. A control unit 26 is a CPU for controlling the respective units 21 to 25 and is a unit for performing operation control for the respective units in accordance with program procedures stored in a memory 27. Note that the memory 27 also has a function as a work memory for the CPU 26. Reference numeral 28 denotes a common bus.

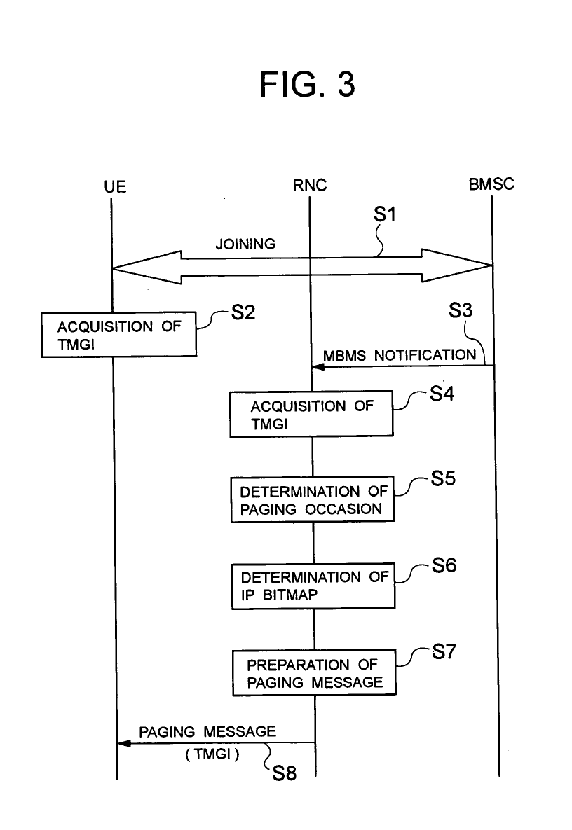

FIG. 3 is a schematic sequence diagram showing an operation of the embodiment of the present invention. In the case in which a certain user desires to receive a service of the MBMS, “JOINING” processing (step S1) is performed in accordance with a predetermined procedure between a UE of the user and the BMSC 1. In this processing, since a TMGI, which is an identifier peculiar to the MBMS for identifying a service of the MBMS, is sent from the BMSC 1 to the UE, the UE acquires this TMGI (step S2).

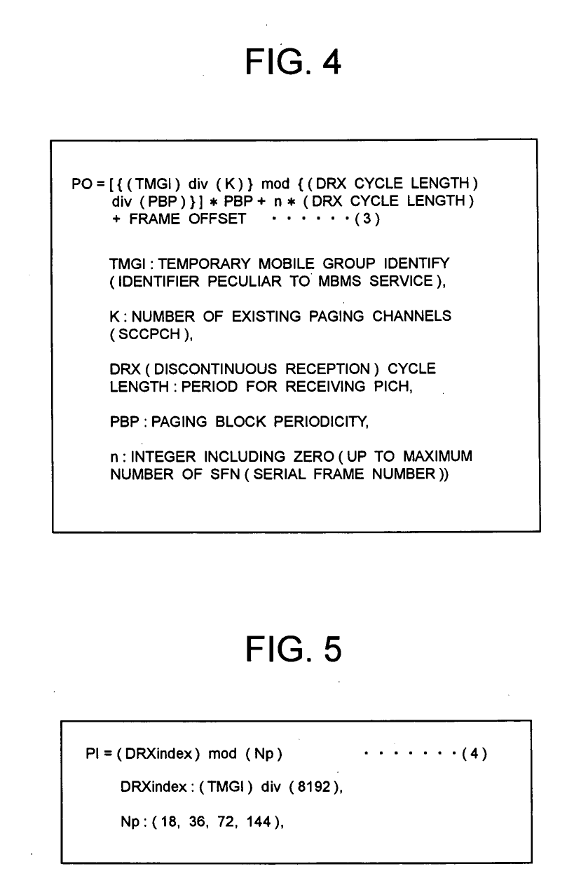

Then, when an “MBMS NOTIFICATION” message for notifying that contents of the MBMS service are to be delivered is sent to the RNC from the MBSC 1 (step S3), the RNC acquires a TMGI included in this message (step S4). A frame timing (PO) of the ICH is determined by the PAGING OCCASION determination unit 22 using this TMGI (step S5). In this case, the PO is determined using expression (3) shown in FIG. 4.

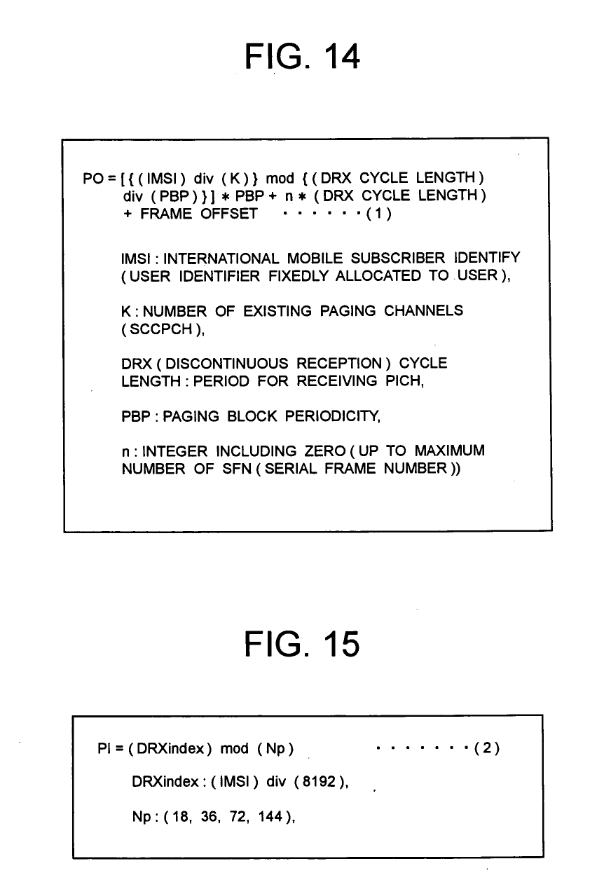

Comparing expression (3) in FIG. 4 and expression (1) in FIG. 14, whereas timing (PO) for paging is determined using an IMSI in expression (1), PO is determined using the TMGI in this embodiment. In addition, a PI bitmap is also determined using the TMGI in the PI bitmap determination unit 23 (step S6). In this case, the PI bitmap is determined using the TMSI as shown in expression (4) in FIG. 5 instead of the IMSI in expression (2) in FIG. 15.

Thereafter, a paging message is prepared by the paging message preparation unit 24 (step S7). Then, a TMGI specifying a group of UEs, to which contents data of this MBMS service should be delivered, is superimposed on a PCH on an S-CCPCH corresponding to a PI of the PICH and sent (step S8). In the UE, the TMGI acquired in step S2 and the TMGI on the PCH are compared and, if both the TMGIs coincide with each other, the service data of the MBMS is received.

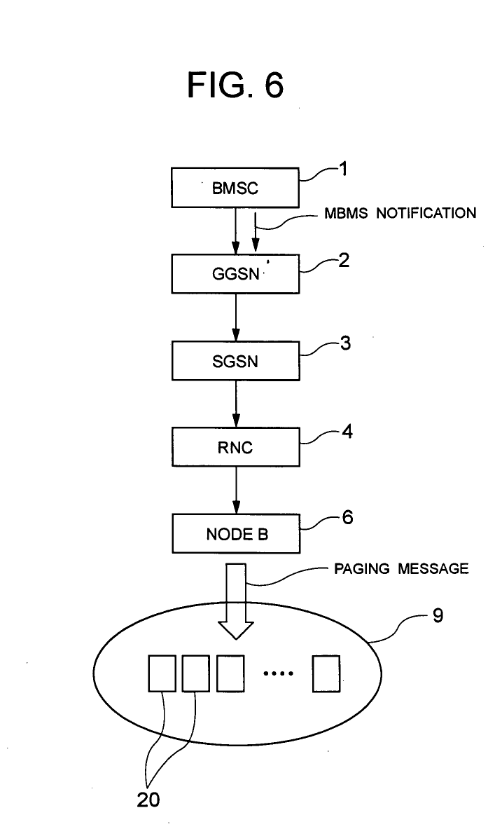

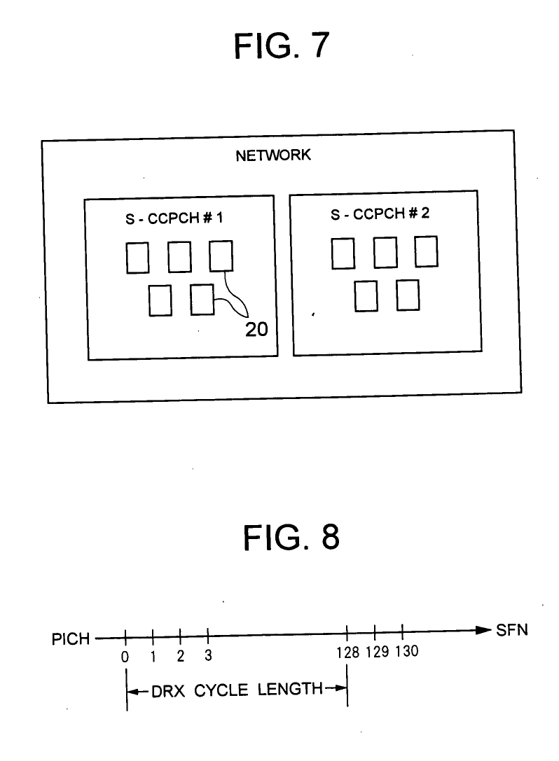

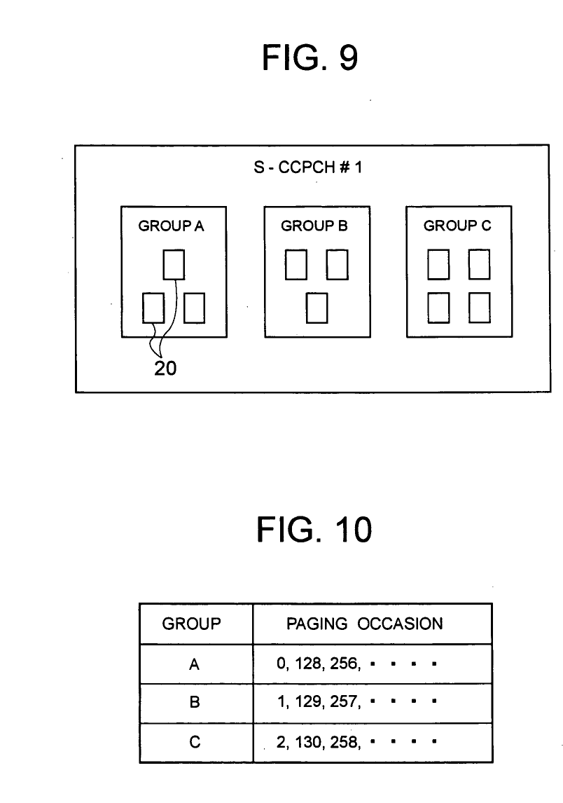

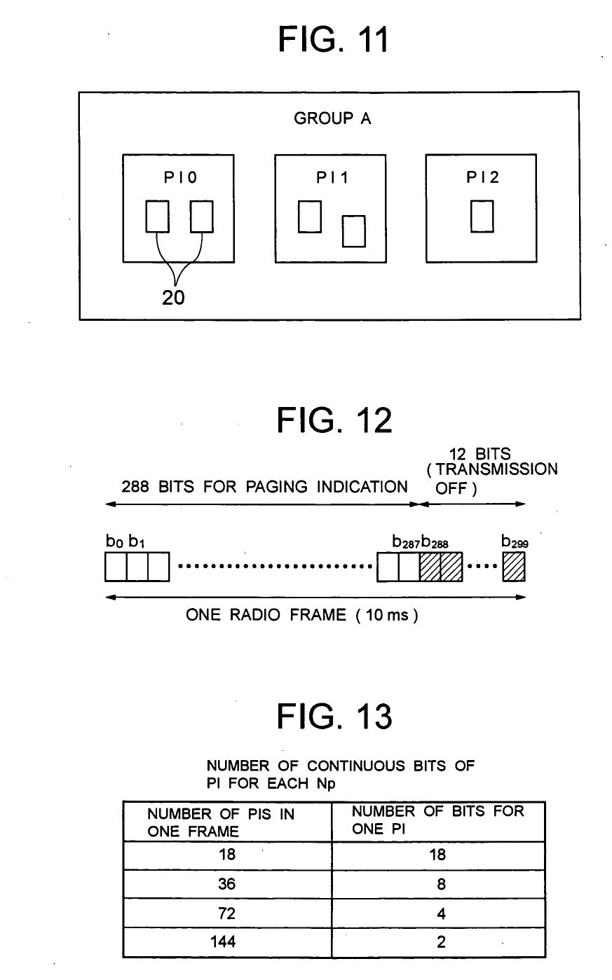

FIG. 6 is a diagram for explaining an effect of the embodiment of the present invention. Portions equivalent to those in FIG. 16 are denoted by the identical reference numerals and symbols. In the conventional example of FIG. 16, a paging message is sent from the NodeB 6 to the respective UEs 20 (the group of UEs which receive delivery of the MBMS service data) individually. On the other hand, in this embodiment, a common paging message is sent from the NodeB 6 to the respective UEs 20 (the group of UEs which receive delivery of the MBMS service data). Whereas a paging message is prepared using an IMSI, which is an individual identifier, for the respective UEs in the conventional example, a paging message is prepared for the group of UEs, which receive an MBMS service, using a TMGI peculiar to the service in the present invention. Thus, a common paging message is sent to this group of UEs, and congestion does not occur.

As described above, according to the present invention, paging processing with respect to a group of UEs, which receive an MBMS service, is performed using an identifier TMGI peculiar to this MBMS service. Thus, there is an effect that a paging message can be made common to the group of UEs and congestion at the time of the paging processing is eliminated. In addition, the paging processing is not performed for each UE. Thus, there is an effect that an influence among MBMS users decreases.

What is claimed is:

1. A mobile communication system having a function of delivering data of an identical service to a plurality of radio terminals,
wherein information for paging with respect to a radio terminal, which receives delivery of the service, is generated using identification information peculiar to the service.

2. The mobile communication system according to claim 1,
wherein the information for paging includes a downlink common channel, which sends a paging message, and a paging indicator channel, which accompanies the downlink common channel and sends information indicating presence or absence of an incoming call with respect to a radio terminal receiving delivery of the service, and
the information indicating presence or absence of an incoming call and transmission timing of the information are generated according to identification information peculiar to the service.

3. The mobile communication system according to claim 2,
wherein the identification information peculiar to the service is superimposed on an indication bit for a paging group (incoming call group) indicating presence or absence of a voice incoming call in the paging indicator channel.

4. The moving communication channel according to claim 1,
wherein the information peculiar to the service is notified to said radio terminal receiving the service, and said radio terminal receives the information for paging on the basis of the information peculiar to the service.

5. A radio network controller in a mobile communication system having a function of delivering data of an identical service to a plurality of radio terminals, comprising means for generating information for paging with respect to a radio terminal, which receives delivery of the service, by using identification information peculiar to the service.

6. The radio network controller according to claim 5,
wherein the information for paging includes a downlink common channel, which sends a paging message, and a paging indicator channel, which accompanies the downlink common channel and sends information indicating presence or absence of an incoming call with respect to a radio terminal receiving delivery of the service, and
said means generates the information indicating presence or absence of an incoming call and transmission timing of the information according to identification information peculiar to the service.

7. The radio network controller according to claim 6,
wherein the identification information peculiar to the service is superimposed on an indication bit for a paging group (incoming call group) indicating presence or absence of a voice incoming call in the paging indicator channel.

8. The radio network controller according to claim 6,
wherein the information indicating presence or absence of an incoming call (Paging Indicator: PI) is determined according to the following expression:
PI=(DRXindex) mod (Np),
DRXindex=(TMGI) div (8192)
Np=(18, 36, 72, 144)
TMGI=Temporary Mobile Group Identify (the identification information peculiar to the service).

9. The radio network controller according to claim 6,
wherein the transmission timing (Paging Occasion: PO) is determined according to the following expression:
PO=[{(TMGI) div (K)}mod {(DRX cycle length) div (PBP)}]*PBP+n*(DRX cycle length)+Frame Offset,
TMGI=Temporary Mobile Group Identify (the identification information peculiar to the service)
K: the number of existing paging channels,
DRX (Discontinuous Reception) cycle length: a period for receiving the paging indicator channel,
PBP: Paging Block Periodicity,
n: an integer including zero (up to a maximum number of an SFN (Serial Frame Number)).

10. A operation control method for a radio network controller in a mobile communication system having a function of delivering data of an identical service to a plurality of radio terminals, comprising a step of generating information for paging with respect to a radio terminal, which receives delivery of the service, using identification information peculiar to the service.

11. The operation control method according to claim 10,
wherein the information for paging includes a downlink common channel, which sends a paging message, and a paging indicator channel, which accompanies the downlink common channel and sends information indicating presence or absence of an incoming call with respect to a radio terminal receiving delivery of the service, and
said step generates the information indicating presence or absence of an incoming call and transmission timing of the information according to identification information peculiar to the service.

12. The operation control method according to claim 11,
wherein the identification information peculiar to the service is superimposed on an indication bit for a paging group (incoming call group) indicating presence or absence of a voice incoming call in the paging indicator channel.

13. The operation control method according to claim 11,
wherein the information indicating presence or absence of an incoming call (Paging Indicator: PI) is determined according to the following expression:
PI=(DRXindex) mod (Np),
DRXindex=(TMGI) div (8192)
Np=(18, 36, 72, 144)
TMGI=Temporary Mobile Group Identify (the identification information peculiar to the service).

14. The operation control method according to claim 11, wherein the transmission timing (Paging Occasion: PO) is determined according to the following expression:
PO=[{(TMGI)div(K)}mod{(DRX cycle length)div(PBP)}]*PBP+n*(DRX cycle length)+Frame Offset,
TMGI=Temporary Mobile Group Identify (the identification information peculiar to the service)
K: the number of existing paging channels,
DRX (Discontinuous Reception) cycle length: a period for receiving the paging indicator channel,
PBP: Paging Block Periodicity,
n: an integer including zero (up to a maximum number of an SFN (Serial Frame Number)).

15. A radio terminal in a mobile communication system having a function of delivering data of an identical service to a plurality of users,
wherein identification information peculiar to the service is received from a network side at the time when said radio terminal joins the service, and information for paging is received on the basis of the identification information.

16. A program for causing a computer to execute an operation control method for a radio network controller in a mobile communication system having a function of delivering data of an identical service to a plurality of radio terminals, comprising a step of generating information for paging with respect to a radio terminal, which receives delivery of the service, using identification information peculiar to the service.
